(19) United States
(12) Patent Application Publication
(10) Pub. No.: US 2009/0105097 A1
(43) Pub. Date: Apr. 23, 2009

(54) Degradable Friction Reducer

(76) Inventors: Carlos Abad, Richmond, TX (US); Kay Robinson, Cambridge (GB); Trevor Lloyd Hughes, Cambridge (GB)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 12/255,386

(22) Filed: Oct. 21, 2008

Related U.S. Application Data
(60) Provisional application No. 60/981,633, filed on Oct. 22, 2007.

(51) Int. Cl. C09K 8/12

(52) U.S. Cl. 507/241

(57) ABSTRACT

Novel wellbore service fluids are disclosed. The fluid may include an aqueous solvent and a synthetic degradable polymer that is soluble in the solvent. In a controlled way the molecular weight of the polymer may be reduced in response to internal or external triggers at the required time and temperature. The polymers are formed by essentially non degradable polymer chains “polymer type A” copolymerized with essentially degradable polymer chains “polymer type B”. This feature of “selective degradation” is not present in any of the polymeric fluids known as friction reducers.

### CROSS REFERENCE TO RELATED APPLICATION(S)

This application claims the benefit of and priority to U.S. 60/981,633, filed Oct. 22, 2007, and incorporated in its entirety herein.

### BACKGROUND

The statements in this section merely provide background information related to the present disclosure and may not constitute prior art.

The invention relates to stimulation of wells penetrating subterranean formations. In particular it relates to methods and compositions required for the execution of fracturing treatments and gravel packing treatments. More particularly, it relates to methods and compositions containing water soluble degradable synthetic polymers required for the execution of high rate fracturing treatments (slick water treatments) and high rate gravel packing treatments (water packs)

Hydrocarbons (oil, condensate, and gas) are typically produced from wells that are drilled into the formations that contain them. For a variety of reasons, such as inherently low permeability of the reservoirs or damage to the formation caused by drilling and completion of the well, the flow of hydrocarbons into the well is often undesirably low. In this case, the well is “stimulated,” for example using hydraulic fracturing, chemical (usually acid) stimulation, or a combination of the two (called acid fracturing or fracture acidizing).

Hydraulic fracturing involves injecting fluids into a formation at high pressures and rates such that the reservoir rock fails and forms a fracture (or fracture network). Proppants are typically injected in fracturing fluids after the pad to hold the fracture(s) open after the pressure is released. In chemical (acid) stimulation treatments, flow capacity is improved by dissolving materials in the formation.

In hydraulic and acid fracturing, a first viscous fluid called a “pad” is typically injected into the formation to initiate and propagate the fracture. In hydraulic fracturing this fluid is followed by a second viscous fluid that contains a proppant to keep the fracture open after the pumping pressure is released. Granular proppant materials may include sand, ceramic beads, or other materials. In “acid” fracturing, the second fluid contains an acid or other chemical such as a chelating agent that can dissolve part of the rock, causing irregular etching of the fracture face and removal of some of the mineral matter, resulting in the fracture not completely closing when the pumping is stopped.

Occasionally, hydraulic fracturing is done without a highly viscosified fluid (i.e., slick water) to minimize the damage caused by polymers or the cost of other viscosifiers. These slick water treatments are often carried out by injecting into the fluid stream very small concentrations of a compound or mixture of compounds aimed to reduce the friction in the well with minimal or negligible viscosification, and therefore minimize the horsepower required on location to execute the fracturing operation. Often high molecular weight polymers are used as friction reducers. Even if the concentration of friction reducer is generally low, the high molecular weight polymers used as friction reducers can concentrate in the proppant pack or in the fracture face, what is believed to impair the production from certain formations such as low permeability gas bearing sandstone reservoirs or gas bearing shale reservoirs. Therefore the need for the development of non damaging friction reducers arises. Typical breakers such as oxidizer or enzymes often are not very effective at all at breaking the chains of the conventional friction reducers.

Wells tend to produce sand and fines from the formation. In order to prevent damage to the surface equipment, and ensure high productivity gravel packing treatments are carried out. In gravel packing, sand or gravel is placed into the space between a well (open formation or casing) and a screen. Fluids used to carry the sand are normally viscous fluids. In some particular applications sand or gravel is transported at high rates without the need for a viscous carrying fluid (water packs). These water packs might be carried out by injecting into the fluid stream small concentrations of a compound or mixture of compounds aimed to reduce the friction in the well with minimal or negligible viscosification, and therefore minimize the horsepower required on location to execute the gravel packing operation, or extend the length of the well that can be treated for horizontal wells. Often high molecular weight polymers are used as friction reducers. Even if the concentration of friction reducer is generally low, the high molecular weight polymers used as friction reducers can concentrate in the gravel pack, what is believed to impair the production. Therefore the need for the development of non damaging friction reducers arises also in gravel packing treatments.

The fluids of the invention and the methods of use of the current invention differ from those degradable fluids in the viscosity requirements for the treatment to be effective, as disclosed by Abad et al. in the patent application filed Jan. 11, 2005, Application number: GB 0500432.0/international application number PCT/GB2006/00089 which was published on Jul. 20, 2006, and U.S. patent application publication number 2006/075154, all incorporated herein in their entirety by reference thereto. Abad et al disclose, in part, viscosifiers containing degradable bonds, where as the polymers and fluids disclosed in the current invention are not necessarily high viscosity fluids, but are characterized by low friction pressure when pumped at low concentrations through tubes and wells.

### SUMMARY OF SOME ILLUSTRATIVE EMBODIMENTS

In some embodiments, a novel type of wellbore service fluid is described. In an embodiment, the fluid may include an aqueous solvent and a synthetic degradable polymer that is soluble in the solvent. In a “selective or controlled degradation” the molecular weight of the polymer may be reduced in response to internal or external triggers and the required time and temperature. This feature of “selective or controlled degradation” is not present in any of the polymeric fluids known to date as friction reducers. This “selective or controlled degradation” is built into the structure of the polymer at the synthetic steps. The disclosed synthetic copolymer is formed by essentially non degradable polymer chains “polymer type A” copolymerized with essentially degradable polymer chains “polymer type B”. This involves the use of a polymer of structure -[(A)ₓ-(B)_{y}]_{z}— for use as a friction reducing agent for wellbore fluids where x, y, z are natural numbers higher than 1, and A, the “polymer type A”, is any polymer structure comprising essentially non degradable polymer chains, while B, the “polymer type B”, is any polymer structure comprising some degradable polymer chains with the condition that the resulting polymer structure -[(A)ₓ-(B)_{y}]_{z}— is an aqueous solvent soluble polymer. An aqueous solvent is a solvent selected from the list of water, deionized water, city water, fresh water, produced water, purified water; aqueous solutions of inorganic salts such as sodium chloride, calcium chloride, potassium bromide, tetramethyl ammonium chloride, sodium bromide, calcium bromide, cesium formate, and others and combinations thereof, aqueous solutions of small polar organic molecules such as methanol, ethanol, 2butoxyethanol, and the like.

In certain embodiments, the polymer is linear. Other possible structures covered by the current invention are branched polymers, star polymers, comb polymers, crosslinked, slightly crosslinked, and hyper-branched polymers. Linear structures are preferred as they provide the highest friction reduction per unit weight. The synthetic polymer, in accordance with embodiments, includes at least one degradable chemical bond in the polymer backbone. Degradable chemical bonds are those that may be “selectively degraded”, meaning that the rest of the bonds in the backbone are not substantially affected by the degradation process, and that this selective degradation may be triggered at an appropriate time by a combination of temperature, and catalyst. The degradable bonds are bonds pertaining to functional organic groups such as nitroxyl, azo, peroxy, perester, percarbonate, carbonate, ester, (carboxylic acid ester, thioester, or sulfonic acid ester), amide, sulfonamide, urea, urethane and the like bonds. In contrast, carbon-carbon bonds (single double or tripe bonds) such as those forming the backbone of common synthetic friction reducers are considered non degradable.

The fluids can include polymers whose structure is obtained by different polymerization methods such as addition polymerization, condensation polymerization, or functional group coupling reactions of structures that will be called “monomers”.

It is important to note that in the current invention the term “monomer” is employed to name the repeating building blocks in the final polymer architecture, independently of their molecular weight. Thus “monomers” according to the invention can refer to monomer, functional oligomers, macroinitiators, macromonomers, and or functional polymers capable of further reacting as repeating units and further increase the molecular weight of the synthetic polymer of the invention.

In an embodiment, the fluid comprises a polymer obtained by means of some type of addition copolymerization in a suitable reaction medium of at least one monomer, “monomer type A”, capable of producing upon polymerization non degradable polymer chains “polymer type A” and at least one monomer, “degradable monomer” or “monomer type B” capable of producing upon polymerization degradable polymer chains “polymer type B”.

Suitable methods of addition polymerization include but are not restricted to free radical polymerization, controlled radical polymerization such as ATRP (atom transfer radical polymerization), RAFT (reversible addition-fragmentation chain transfer), NMP (nitroxide mediated polymerization), cationic polymerization, or an ionic polymerization. Radical and controlled radical polymerization methods are preferred. Suitable reaction media include but are not restricted to water solution, aqueous solution (comprising water and polarity changing water soluble organic compounds such as alcohols ethers, esters, ketones and or hydroxy ethers), emulsion, and microemulsion.

In an embodiment, the fluid comprises a polymer obtained by means of some type of condensation or coupling reaction of at least one functional polymer obtained by addition polymerization in a suitable reaction medium of at least one monomer, “monomer type A”, capable of producing non degradable polymer chains “polymer type A” with at least one functional monomer, “degradable monomer” or “monomer type B” capable of producing degradable polymer chains “polymer type B”. In certain embodiments of the present invention, the polymer is linear. Other possible structures covered by the current invention are branched polymers, star polymers, comb polymers, crosslinked, slightly crosslinked, and hyper-branched polymers. Linear structures are preferred as they provide the highest friction reduction per unit weight. The polymer, in accordance with embodiments of the present invention, may provide that at least one of the chemical bonds present in the polymer backbone may be “selectively degraded” and that this selective degradation may be triggered at an appropriate time. The degradable bonds may be carbonate, ester (i.e. carboxylic acid ester, thioester, or sulfonic acid ester), amide, sulfonamide, urea, urethane and the like bonds. Suitable methods of coupling reaction are condensations such as esterification, amidation, SN reactions, or addition reactions. Suitable reaction media include but are not restricted to water solution, aqueous solution (comprising water and polarity changing water soluble organic compounds such as alcohols ethers, esters, ketones and or hydroxy ethers), organic solution, emulsion, and microemulsion.

In an embodiment of the present invention, the fluid comprises a polymer obtained by means of some type of condensation or coupling reaction of at least one functional polymer obtained by addition polymerization in a suitable reaction medium of at least one monomer, “monomer type A”, capable of producing non degradable polymer chains “polymer type A” and one at least one functional monomer, “degradable monomer” or “monomer type B”, where the chemical bond resulting of the coupling of the “polymer type A” and the “monomer type B” is a degradable coupling bond. In certain embodiments of the present invention, the polymer is linear. Other possible structures covered by the current invention are branched polymers, star polymers, comb polymers, crosslinked, slightly crosslinked, and hyper-branched polymers. Linear structures are preferred as they provide the highest friction reduction per unit weight. The polymer, in accordance with embodiments of the present invention, may provide that at least one of the chemical bonds present in the polymer backbone may be “selectively degraded” and that this selective degradation may be triggered at an appropriate time. The degradable bonds may be nitroxyl, imine, azo, peroxy, perester, percarbonate, carbonate, ester, acetal, thioester, sulfonic ester, amide, sulfonamide, urea, urethane and the like bonds. Suitable methods of coupling reaction are condensations such as esterification, amidation, SN reactions, or addition reactions. Suitable reaction media include but are not restricted to water solution, aqueous solution (comprising water and polarity changing water soluble organic compounds such as alcohols ethers, esters, ketones and or hydroxy ethers), organic solution, emulsion, and microemulsion.

As an overall effect of embodiments of the present invention, the novel synthetic polymers may be capable of reducing the friction pressure required to pump aqueous solutions of said polymers as compared to pumping water or brine. Once the treatment is completed, the polymer can be degraded selectively and the loci in the backbone where the degradable bonds in the “degradable monomer B” or the degradable coupling bonds are located. After this selective degradation process the polymer molecular weight is reduced to essentially that of the “polymer type A” segments, minimizing the chances of damaging the formation or gravel pack.

In the embodiments of the invention the “monomers type A”, and “monomer type B”, are carefully selected in terms of chemical structure, molecular weight, concentration per polymer molecule, and distribution (random or blocky) because these parameters determine the final structure of the polymer (molecular weight and conformation in solution) and therefore its ability to reduce friction pressure as a suitable wellbore fluid, and also the size of the polymer residues after the selective degradation process. Molecular weight and degree of crosslinking of the polymer are critical structural parameters of the polymer architecture with impact on the friction reducing capability of the fluids formulated with the polymers of the invention. As it can become obvious to those skilled in the art of polymerization, polymer molecular weight can be controlled by means of a careful selection the polymerization method, catalyst, reaction temperature, type of initiator, chain transfer agent, and reaction media amongst others. The degree of crosslinking can be controlled by careful selection of the monomers and functional polymers involved in the synthesis, as well as their respective concentrations.

The most widely cited definitions for degradability are provided by the ASTM/ISR (American Society for Testing and Materials/Institute for Standard Research) and CEN (European Committee for Standardization). The ASTM definition is: “A material is called degradable with respect to specific environmental conditions if it undergoes degradation to a specific extent within a given time measured by specific standard test methods”. Based on the available definitions and the specific needs of the oilfield industry, in the foregoing, the polymers that can be regarded as degradable or degrading are those whose degradation can be achieved at the selected “polymer type B” groups to such an extent that the “polymer type A” fragments are released in a state which is essentially unaffected by the degradation process and remain perfectly soluble.

The degradable polymers formed by copolymerizing monomers resulting in at least one essentially non-degradable “polymer type A” with at least one monomer whose resulting in an essentially degradable “polymer type B” polymer containing preferably in the backbone at least one, and more preferably at least two, of the following bonds: i) those pertaining to the group of covalent bonds that can be degraded by a hydrolytic mechanism by means of acids, encapsulated acids, acid precursors, bases, encapsulated bases or base precursors such as imine, carbonate, ester, sulfonic ester, thioester, amide, sulphonamide, urea, urethane; ii) those pertaining to the group of chemical bonds that can be cleaved for example by means of heat/temperature or a redox reaction triggered by the release of a reducing agent such as nitroxide, azo, peroxide, perester, percarbonate, iii) combinations of two or more of the bonds described in i) through ii) that may be degraded by hydrolytic means, temperature means, redox means.

If the fluid described in the current invention is to be used as a fracturing fluid, a method for using such new fluid is also herein disclosed. A fracturing fluid based on the fluid described above may comprise a solvent (aqueous or organic), the new degradable polymer soluble in the solvent, and any of the usual additives in fracturing fluids, namely brine, organic solvents and oils, diesel, other soluble or insoluble polymers, surfactants, viscoelastic surfactants, fluid loss additives, breakers, encapsulated breakers, proppant, fibers, biocides, scale inhibitors, etc.

In order to make the polymer disclosed an efficient friction reducer; the polymerization process has to allow the polymer to grow to a sufficiently high molecular weight.

In contrast to the polymeric friction reducing fluids currently used in high rate water fracturing or high rate water gravel packing, the polymer of the invention can be selectively degraded to form low viscosity soluble degradation products, which can be easily removed by formation fluids to create a “clean” propped fracture or clean gravel pack.

In the fracturing application or gravel packing application, depending on the design and pumping rate, a typical time at which the polymer should degrade is in excess of the range 1-5 hours. Such a decrease in molecular weight is appropriate at some time after the fracture has closed during the backflow of formation fluids from the reservoir via the fracture to the wellbore. This decrease in molecular weight will facilitate easier clean-up of the fracturing fluid from the propped fracture, thereby maximizing the production rate.

In another embodiment, the degradable polymers of the invention are synthesized, prepared and packaged prior to delivery to the pumping location.

In another embodiment, the degradable polymer is prepared on location, through reaction of “monomer type A” and “monomer type B” in the hydration tanks, or in other specifically designed or dedicated tanks or vessels, or mixed on the fly.

These and other features of the invention, preferred embodiments and variants thereof, possible applications and advantages will become appreciated and understood by those skilled in the art from the following detailed description and drawings.

### BRIEF DESCRIPTION OF THE DRAWINGS

FIG. 1: Degradable friction reducing polymer containing several degradable carboxylic acid ester groups according to example 1.

FIG. 2: Degradable friction reducing polymer containing several degradable carboxylic acid ester groups according to example 2.

FIG. 3: Degradable friction reducing polymer containing several degradable carboxylic acid ester groups according to example 3.

FIG. 4: Degradable friction reducing polymer containing several degradable carboxylic acid ester groups according to example 4.

FIG. 5: Degradable friction reducing polymer containing several degradable carboxylic acid ester groups according to example 5.

FIG. 6: Degradable friction reducing polymer containing several degradable carboxylic acid ester groups according to example 6.

FIG. 7: Degradable friction reducing polymer containing several degradable carboxylic acid ester groups according to example 7.

FIG. 8: Degradable friction reducing polymer containing several degradable carboxylic acid ester groups according to example 8.

FIG. 9: Degradable friction reducing polymer containing several degradable azo groups according to example 9.

FIG. 10: Degradable friction reducing polymer containing several degradable azo groups according to example 10.

FIG. 11: Degradable friction reducing polymer containing several degradable carboxylic acid ester groups according to example 11.

FIG. 12: Degradable friction reducing polymer containing several degradable carboxylic acid ester groups according to example 12.

FIG. 13: Degradable friction reducing polymer containing several degradable imine groups according to example 13.

FIG. 14: Degradable friction reducing polymer containing several degradable sulfonic acid ester and carboxylic acid ester groups according to example 14.

FIG. 15: Degradable friction reducing polymer containing several degradable amide and carboxylic acid ester groups according to example 15.

FIG. 16: Friction reduction in a 6 ft ⅜″ tubing for fluids formulated using the degradable friction reducing polymer of example 16 as a function of concentration at two different flow rates.

FIG. 17: Friction reduction in a 6 ft ⅜″ tubing for fluids formulated using two concentrations of the degradable friction reducing polymer of examples 17-2 and 17-8 as compared to fluids formulated using two concentrations of polyAMAA of examples 17-1 and 17-9 as a function of flow rate.

### DETAILED DESCRIPTION OF SOME EMBODIMENTS

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure.

The description and examples are presented solely for the purpose of illustrating the preferred embodiments of the invention and should not be construed as a limitation to the scope and applicability of the invention. While the compositions of the present invention are described herein as comprising certain materials, it should be understood that the composition could optionally comprise two or more chemically different materials. In addition, the composition can also comprise some components other than the ones already cited. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possession of the entire range and all points within the range.

Disclosed are synthetic copolymers of formula -[(A)ₓ-(B)_{y}]_{z}— for use as a friction reducing agent for wellbore fluids where x, y, z are natural numbers higher than 1, and A, the “polymer type A”, is any polymer structure comprising essentially non degradable polymer chains, while B, the “polymer type B” is any polymer structure comprising some degradable polymer chains with the condition that the resulting polymer structure -[(A)ₓ-(B)_{y}]_{z}— is an aqueous solvent soluble polymer. An aqueous solvent is a solvent selected from the list of water, deionized water, city water, fresh water, produced water, purified water; aqueous solutions of inorganic salts such as sodium chloride, calcium chloride, potassium bromide, tetramethyl ammonium chloride, sodium bromide, calcium bromide, cesium formate, and others and combinations thereof, aqueous solutions of small polar organic molecules such as methanol, ethanol, 2butoxyethanol, and the like.

In addition what it is disclosed are fluids for use as high water rate fracturing fluids or high rate water pack fluids comprising synthetic copolymers of formula -[(A)ₓ-(B)_{y}]_{z}— for use as a friction reducing agent for wellbore fluids where x, y, z are natural numbers higher than 1, and A, the “polymer type A”, is any polymer structure comprising essentially non degradable polymer chains, while B, the “polymer type B” is any polymer structure comprising some degradable polymer chains with the condition that the resulting polymer structure -[(A)ₓ-(B)_{y}]_{z}— is an aqueous solvent soluble polymer.

The following description of various embodiments of the present invention is merely exemplary in nature and is in no way intended to limit the invention, its application, or uses. In the following detailed description various examples of possible combinations of species of “monomers type A”, or monomers “A”, and “monomers type B”, or monomers “B” are described. In the examples, the monomers “A” and “B” are linked using the reacting groups to generate the degradable copolymers disclosed in this application. It is important to note that the term “monomer” refers herein to compounds susceptible of reacting in such as way as remaining incorporated into a polymer chain, in the backbone, or as part of side chains, or branches.

Amongst the “monomer type A” two types of compounds can be described: i) “monomers A1” are compounds suitable for the invention that can yield aqueous media soluble polymers; ii) “co-monomers A2” are compounds suitable for the invention that that can yield aqueous media soluble polymers when copolymerized in small amounts with those listed as “monomers A1”. Suitable “monomers A1” are compounds can be selected from the group of water soluble monomers resulting in water soluble polymers via polymerization reactions, and partially water soluble or totally water insoluble monomers resulting in water soluble polymers via reactions such as partial polymer hydrolysis. Suitable “monomers A1” are those capable of accepting a proton and remaining positively charged such as acrylamide, methacrylamide, substituted acrylamides, N methylol acrylamide; substituted methacrylamides, allyl amine, diallyl amine, vinyl formamide, vinylhexanamide, and the like, those capable of releasing a proton and remaining negatively charged such as acrylic acid, methacrylic acid, itaconic acid, and the like, permanently charged monomers like anionic monomers such as sulfonate containing monomers such as sodium vinyl sulfonate, sodium styrene sulfonate, sodium alphamethyl styrene sulfonate, acrylamido-methyl-propane sodium sulfonate, methacrylamido-methyl-propane sodium sulfonate and the like, phosphate containing acrylic and methacrylic acid derivatives, cationic monomers such as dimethyl ethylmethacrylamido ammonium chloride, diallyldimethyl ammonium chloride, and the like, zwitterionic betaine monomers such as acrylamidopropyl betaine, and methacrylamidopropyl betaine, zwitterionic sultaine monomers such as acrylamidopropyl sultaine, and methacrylamidopropyl sultaine. Other “monomer type A” are functional polymers and copolymer such as polyamines (copolymers of dimethylamine and epichlorohydrin), polyethylenepolyamines, polyols, functional polyethylene oxide polymers and copolymers.

Suitable “co-monomers A2” are compounds can be selected from the group of partially water soluble or non water soluble monomers, capable of partially hydrolyzing in an aqueous medium resulting in carboxylic acid bearing monomers like non charged alkyl acrylates, methyl acrylate, ethyl acrylate, butyl acrylate isooctylacrylate, dodecyl acrylate, stearyl acrylate, oleyl acrylate and the like; functional acrylates, like glycidyl acrylate, or alkyl methacrylates, like methyl methacrylate, ethyl methacrylate, butyl methacrylate isooctylmethacrylate, dodecyl methacrylate, stearyl methacrylate, oleyl methacrylate and the like, functional methacrylates, like glycidyl methacrylate, and the like; maleic anhydride, allyl succinic anhydride, and the like, partially water soluble or non water soluble monomers, capable of partially hydrolyzing in an aqueous medium resulting in hydroxyl groups bearing monomers such as vinyl esters like vinyl acetate, vinyl propionate, vinyl hexanoate, vinyl ester of versatic acid, and other non hydrolizable such as styrene, ethylene, propylene, butylene, hexene, and others, provided that the polymer obtained by copolymerization with one or more A1 type monomers is water soluble.

Suitable degradable monomers for the invention, “monomers type B”, or monomers “B” can be selected from the group of polyfunctional monomers containing azo, peroxy, perester, percarbonate, carbonate, ester, acetal, thioester, sulfonic ester, amide, sulfonamide, urea, urethane groups, or those yielding carbonate, ester, acetal, thioester, sulfonic ester, amide, sulfonamide, urea, urethane groups by coupling reaction with functional “polymer type A” compounds. Polyfunctional monomers are considered those chemical structures containing more than two functional groups susceptible of being polymerized through specific polymerization addition or condensation reactions. More preferable degradable monomers “B” can be selected from the group of difunctional monomers containing nitroxyl, azo, peroxy, perester, percarbonate, carbonate, ester, thioester, or sulfonic ester, groups, or those yielding carbonate, ester, thioester, and sulfonic ester, groups by reaction with “monomer type A” compounds.

Examples of degradable monomers for the invention, “monomers type B”, are monomers susceptible of addition polymerization such as di-acrylates such as ethylenglycol diacrylate, polyethylenglycol diacrylate, polypropyleneglycol diacrylate, and the like; di-methacrylates such as ethylenglycol dimethacrylate, polyethylenglycol dimethacrylate, polypropyleneglycol dimethacrylate, and the like; N,N′-methylenebisacrylamide, N,N′-methylenebismethacrylamide, and the like;

Difunctional monomers are considered those chemical structures containing only two functional groups susceptible of being polymerized through specific polymerization addition or condensation reactions. Examples of said functional groups are ester, anhydride, amine, alcohol, thiol, isocyanate, acrylate, methacrylate, vinylester, allyl ester, etc. Functional “B” monomers specially suitable for the invention are amongst the following: functional vazo initiators such as those commercially available from Wako Specialty Chemicals such as V-601, VF-096, V-30, VAm-110, VAm-111, VA-080, or VA-086; dimercaptanes such as acetic acid 2-mercapto-1,1′-(1,4-butanediyl) ester; propanoic acid 3-mercapto-1,1′-(1,2-ethanediyl) ester; acetic acid mercapto-1,2,6-hexanetriyl ester; propanoic acid 3-mercapto-1,4-butanediyl ester; acetic acid 2-mercapto-, 1,1′-(1,2-ethanediyl) ester, and the like; bis(2-mercapto ethoxy maleate), bis (2-mercapto ethoxy fumarate), bis(2-mercapto ethoxy glutarate), bis(2-mercapto ethoxy adipate) and the like; diols such as ethyleneglycol, propylene glycol, 1,4 butanediol, 1,6 hexanediol, polyols such as monosaccharides, disaccharides, oligosaccharides, polysaccharides and the like, polyaldehydes such as polyacroleine, glutaraldehyde, 1,6 hexane dial, and the like, diamines, such as hexamethylenediamine, polyamines, such as triethylene tetramine, tetraethylenpentamine, and the like; epoxy containing compounds such as Bis(3,4-epoxycyclohexylmethyl) adipate and the like; isocyanate containing compounds such as poly(ethylene adipate) tolylene 2,4-diisocyanate, and the like; dicarboxylic and polycarboxylic acid acids, such as fumaric acid, maleic acid, glutaric acid, adipic acid, citric acid, and the like, dicarboxylic acid precursors, such as anhydrides, alkyl diesters, or diacyl halides, such as diacyl chlorides. Macro initiators such as nitroxyl, azo, peroxy, perester, or percabonate containing macro initiator are also suitable “monomers type B”. Macro azo initiators VPE-0201, VPE-0401, VPE-0601, VPS-0501 or VPS-1001 from Wako specialty chemicals, and those macroinitiators containing peroxy, perester, percarbonate groups obtained through condensation or addition reactions of common peroxyde, percarbonate or perester radical initiators are suitable examples. Functional macroinitiators such as those obtained by polymerization of vinyl monomers with nitroxyl end groups are also suitable “monomers type B”

Some synthetic copolymers of the invention are linear. Other possible suitable structures are branched polymers, star polymers, comb polymers, and hyper-branched polymers. Linear structures are particularly suitable as they provide the highest friction reduction per unit weight.

Some synthetic copolymers contain at least about 50 wt % non degradable “polymer A” chains, at least about 70 wt % “polymer A” chains, and even at least about 95 wt % non degradable “polymer A” chains.

In some embodiments, friction reducers are those high molecular weight polymers providing at least about 70% drag reduction calculated by comparing the pressure differential for the fluid ΔPfluid as compared to the friction pressure for water ΔPw at the same flow rate, reported as % DR=100*(1−ΔPfluid/ΔPw), at low concentrations. Preferred degradable friction reducers are those providing at least about 70% DR at concentrations below about 5 g/L, while exhibiting solution viscosities lower than about 20 mPa−s at 100 s⁻¹. Degradable friction reducers may also be those providing at least about 70% DR at concentrations below about 1 g/L, while exhibiting solution viscosities lower than about 10 mPa−s at 100 s⁻¹. Also, degradable friction reducers may be those providing at least about 70% DR at concentrations below about 0.5 g/L, while exhibiting solution viscosities lower than about 5 mPa—s at 100 s⁻¹.

Synthetic copolymers may contain at least one monomer including functional groups that can bear negative charges at specific pH ranges such as carboxylate, phosphate or sulfonate. Synthetic copolymers may include at least one monomer comprising functional groups that can bear positive charges at specific pH ranges such as amine and ammonium. Also, synthetic copolymers behave as ampholites, this is, contain at least one monomer comprising functional groups that can bear negative charges at specific pH ranges such as carboxylate, phosphate or sulfonate and at least one monomer comprising functional groups that can bear positive charges at specific pH ranges such as amine and ammonium.

In some embodiments, the slurry contains a brine, which can be a produced formation fluid, or brine prepared from a water source and appropriate salt(s). Also, in some embodiments, the slurry includes a liquid phase and a gas phase (N₂) or even two liquid phases (CO₂). In other embodiments the slurry contains particulates, fibers, crosslinkers, buffers, biocides, scale inhibitors.

### EXAMPLES

The following examples are presented to illustrate the preparation and properties of energized aqueous fluids comprising heteropolysaccharides and a surfactant, and should not be construed to limit the scope of the invention, unless otherwise expressly indicated in the appended claims. All percentages, concentrations, ratios, parts, etc. are by weight unless otherwise noted or apparent from the context of their use.

### Example 1

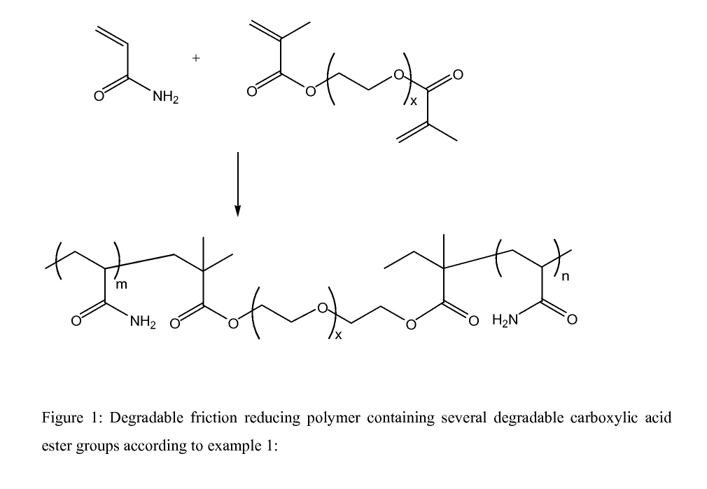

In this example, reaction depicted below, FIG. 1, illustrates a degradable friction reducer, in accordance with an embodiment. This copolymer can be obtained by addition copolymerization of acrylamide CAS 79-06-1 (“A type monomer”) and (poly(ethyleneglycol) bismethacrylate) CAS 25852-47-5 (“B type monomer) in the presence of a polymerization initiator yielding a copolymer containing several degradable carboxylic acid ester links. The copolymer may be used as a friction reducer in wellbore applications.

### Example 2

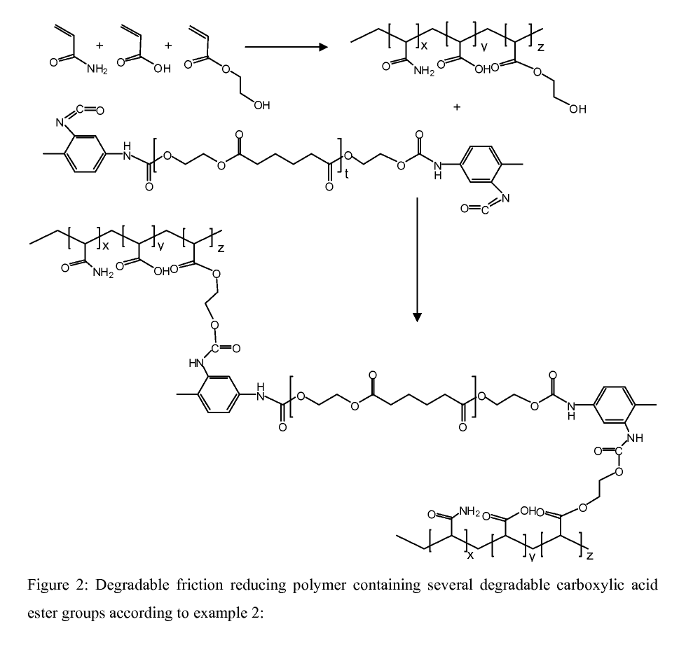

This example, reaction depicted below, FIG. 2, illustrates a degradable friction reducer, in accordance with an embodiment. This copolymer containing several degradable carboxylic acid ester links can be obtained upon reaction of an addition copolymer containing acrylamide CAS 79-06-1, acrylic acid CAS 79-10-7, and hydroxyethyl acrylate CAS 818-61-1, (“A type monomers”), with a suitable amount of Poly(ethyleneadipate)tolylene 2-4 diisocyanate, CAS 9019-92-5, (“B type monomer”). The copolymer may be used as a friction reducer in wellbore applications.

### Example 3

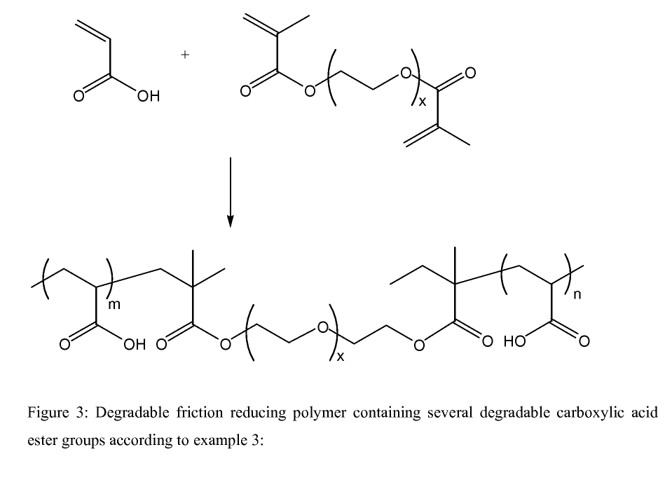

This example, reaction depicted below, FIG. 3, illustrates another degradable friction reducer. This copolymer can be obtained by copolymerization of an acrylic monomer, the “A” monomer, such as acrylic acid CAS 79-10-7, with a “B” building block, such as (poly(ethyleneglycol) bismethacrylate) CAS 25852-47-5 yielding a copolymer containing several degradable carboxylic acid ester links. The copolymer may be used as a friction reducer in wellbore applications.

### Example 4

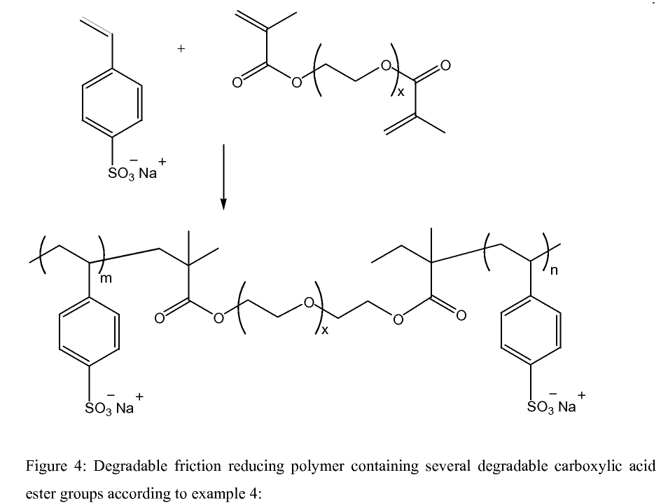

This example, reaction depicted below, FIG. 4, illustrates yet another degradable friction reducer. This copolymer can be obtained by copolymerization of an vinyl monomer, the “A” monomer, such as acrylic acid CAS 79-10-7, sodium salt of styrene sulfonic acid CAS 2695-37-6, with a “B” building block, such as (poly(ethyleneglycol) bismethacrylate) CAS 25852-47-5 yielding a copolymer containing several degradable carboxylic acid ester links. As above, the copolymer may also be used as a friction reducer in wellbore applications.

### Example 5

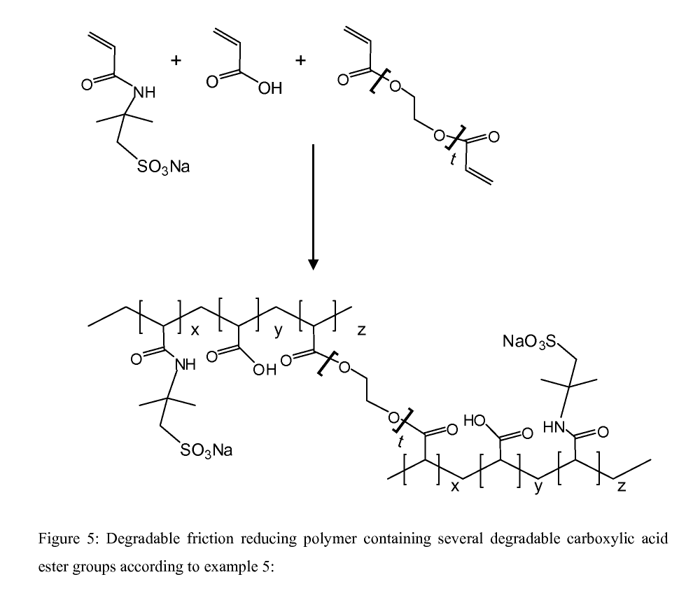

This example, reaction depicted below, FIG. 5, the copolymer can be obtained by copolymerization of an vinyl monomer, the “A” monomer, such as acrylic acid CAS 79-10-7, the sodium salt of acrylamido-methyl-propane sodium sulfonate, CAS 15214-89-8, with a “B” building block, such as (poly(ethyleneglycol) diacrylate) CAS 26570-48-9 yielding a copolymer containing several degradable carboxylic acid ester links, which may be used as a friction reducer in wellbore applications.

### Example 6

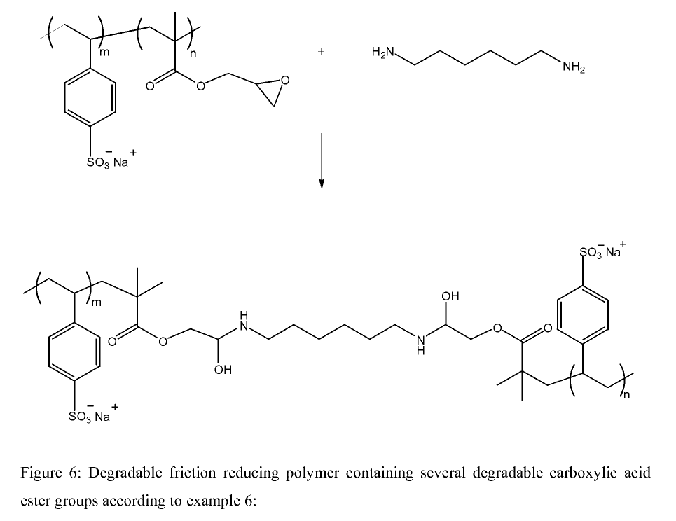

This example, reaction depicted below in FIG. 6, illustrates yet another example of a degradable friction reducer. This copolymer can be obtained by copolymerization of an acrylic monomer, the “A” monomer, such as sodium styrene sulfonic acid salt CAS 2695-37-6, and glycidyl methacrylate CAS 106-91-2, with a “B” monomer such as hexamethylenediamine CAS 124-09-4 yielding a copolymer containing several degradable carboxylic acid ester links. As with any of the examples described in this disclosure, the materials may be used as a friction reducer in wellbore applications.

### Example 7

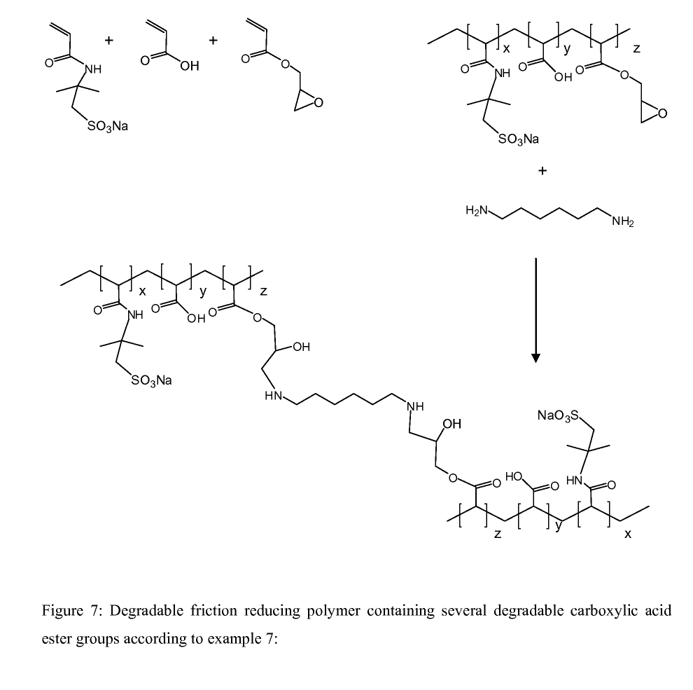

FIG. 7 illustrates a degradable friction reducer, which is a copolymer obtained by copolymerization of an acrylic monomer, the “A” monomer, such as acrylic acid CAS 79-10-7, sodium salt of acrylamido-methyl-propane sodium sulfonate, CAS 1521-89-8, and glycidyl acrylate CAS 106-90-21, with a “B” monomer such as hexamethylenediamine CAS 124-09-4 yielding a copolymer containing several degradable carboxylic acid ester links.

### Example 8

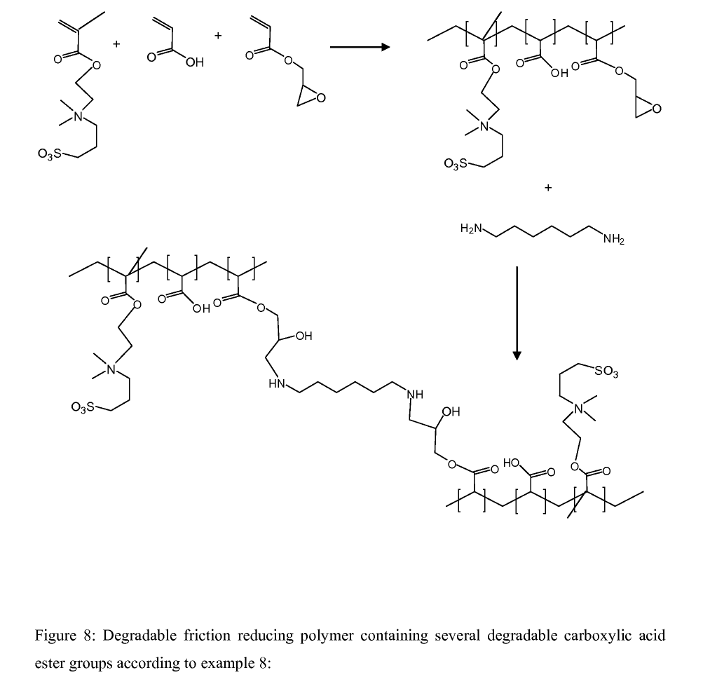

FIG. 8 is another degradable friction reducer useful in some embodiments. This copolymer can be obtained by copolymerization of an acrylic monomer, the “A” monomer, such as acrylic acid CAS 79-10-7, 2-(N-3-Sulfopropyl-N,N-dimethyl ammonium)ethyl methacrylate CAS 3637-26-1, and glycidyl acrylate CAS 106-90-1, with a “B” monomer such as hexamethylenediamine CAS 124-09-4 yielding a copolymer containing several degradable carboxylic acid ester links.

### Example 9

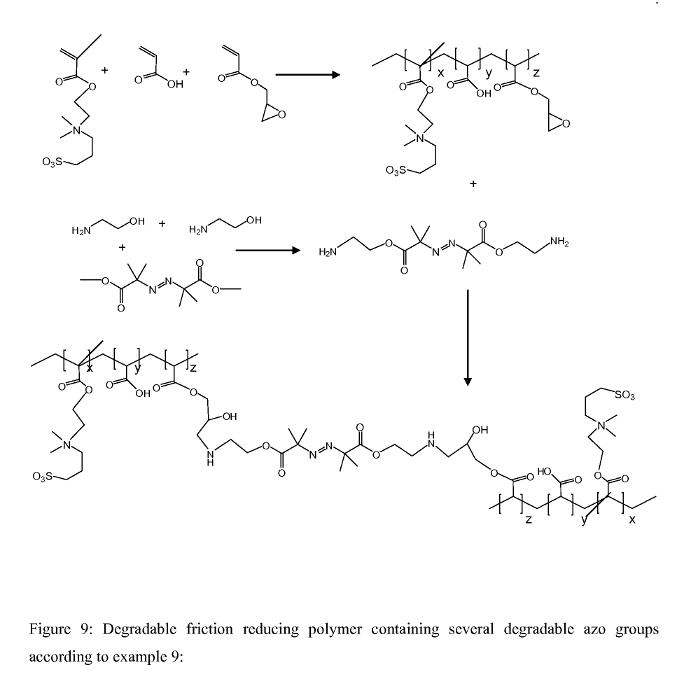

This example, reaction depicted below in FIG. 9, illustrates yet another degradable friction reducer. This copolymer can be obtained by copolymerization of an acrylic monomer, the “A” monomer, such as acrylic acid CAS 79-10-7, sodium salt of acrylamido-methyl-propane sodium sulfonate, CAS 15214-89-8, and glycidyl acrylate CAS 106-90-1, with a “B” monomer such as the transesterification reaction product of ethanolamine CAS 141-43-5 with dimethyl 2,2′ azobis(2-methyl propionate) CAS 2589-57-3 yielding a copolymer containing several azo links.

### Example 10

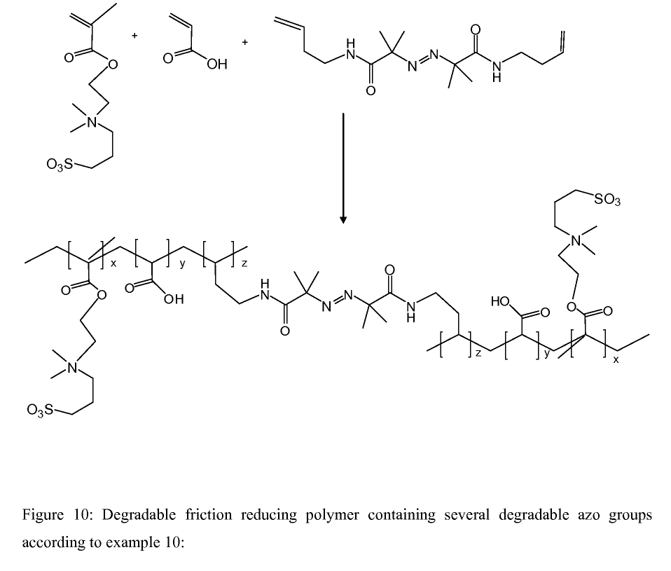

Here, and in FIG. 10, is illustrated another degradable friction reducer. This copolymer can be obtained by copolymerization of an acrylic monomer, the “A” monomer, such as acrylic acid CAS 79-10-7, sodium salt of acrylamido-methyl-propane sodium sulfonate, CAS 15214-89-8, with a “B” monomer such as 2,2′ azobis(N-2-propenyl-2-methylpropionamide) CAS 129136-92-1 yielding a copolymer containing several azo links.

### Example 11

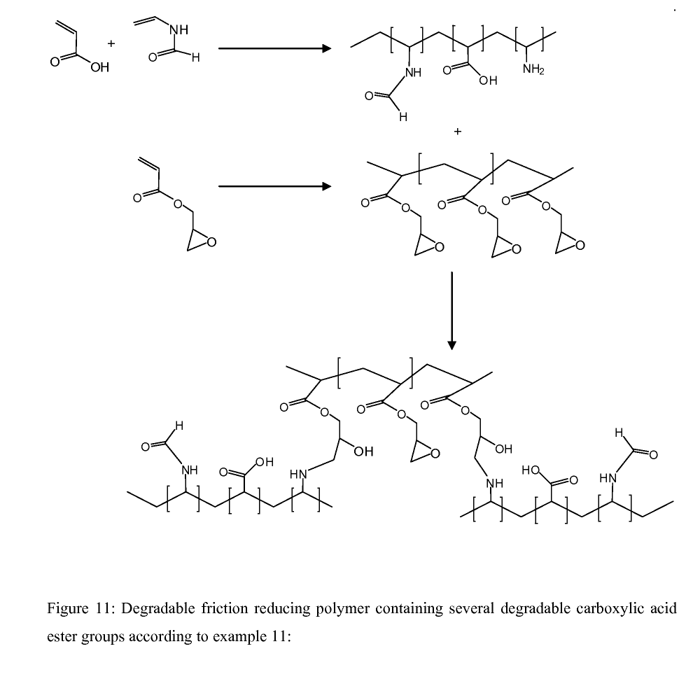

This example, reaction depicted below, FIG. 11, illustrates a degradable friction reducer. This copolymer can be obtained by condensation of a partially hydrolyzed copolymer obtained by addition copolymerization between a vinyl monomer and an acrylic monomer, the “A” monomers, such as acrylic acid CAS 79-10-7, and vinyl formamide CAS 13162-05-5, with a “B” olygomer obtained by radical polymerization of glycidyl acrylate CAS 106-90-1, yielding a copolymer containing several carboxylic acid ester links.

### Example 12

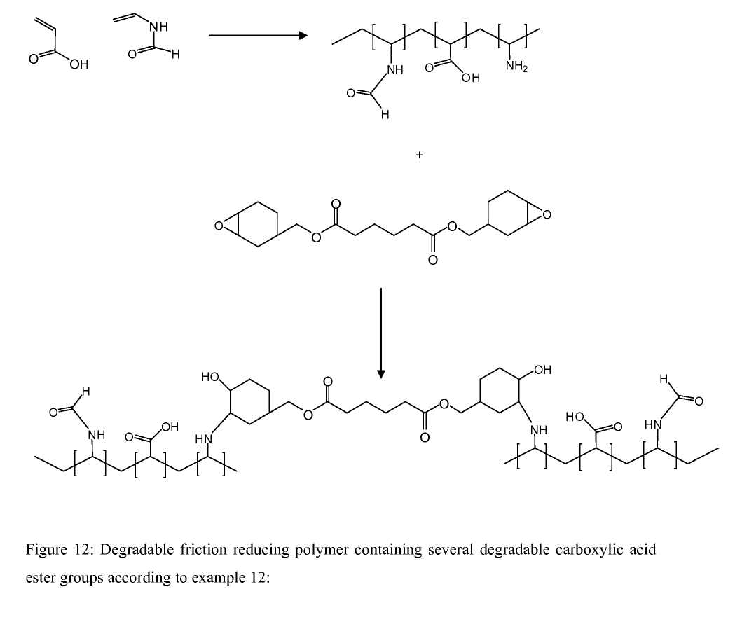

FIG. 12 illustrates another type of degradable friction reducer. This copolymer can be obtained by condensation of a partially hydrolyzed copolymer obtained by addition copolymerization between a vinyl monomer and an acrylic monomer, the “A” monomers, such as acrylic acid CAS 79-10-7, and vinyl formamide CAS 13162-05-5, with a “B monomer” such as Bis(3,4-epoxycyclohexylmethyl) adipate CAS 3130-19-6, yielding a copolymer containing several carboxylic acid ester links.

### Example 13

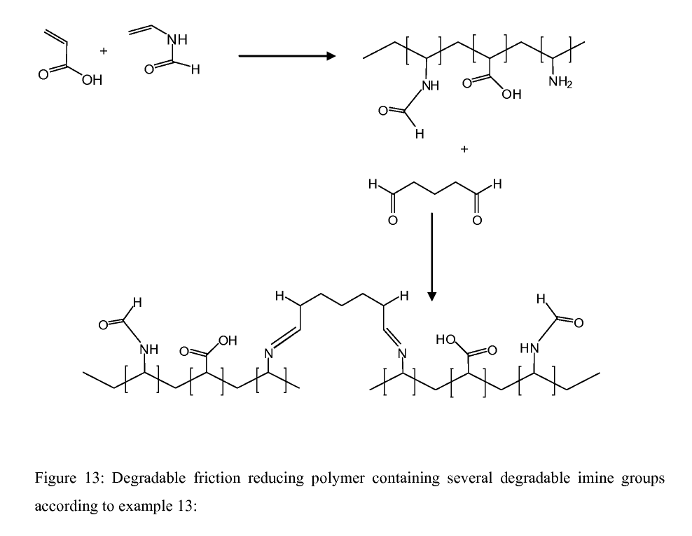

Another degradable friction reducer is shown in the reaction in FIG. 13. This copolymer can be obtained by condensation of a partially hydrolyzed copolymer obtained by addition copolymerization between a vinyl monomer and an acrylic monomer, the “A” monomers, such as acrylic acid CAS 79-10-7, and vinyl formamide CAS 13162-05-5, with a “B monomer” such as glutaraldehyde CAS 111-30-8, yielding a copolymer containing several imino links.

### Example 14

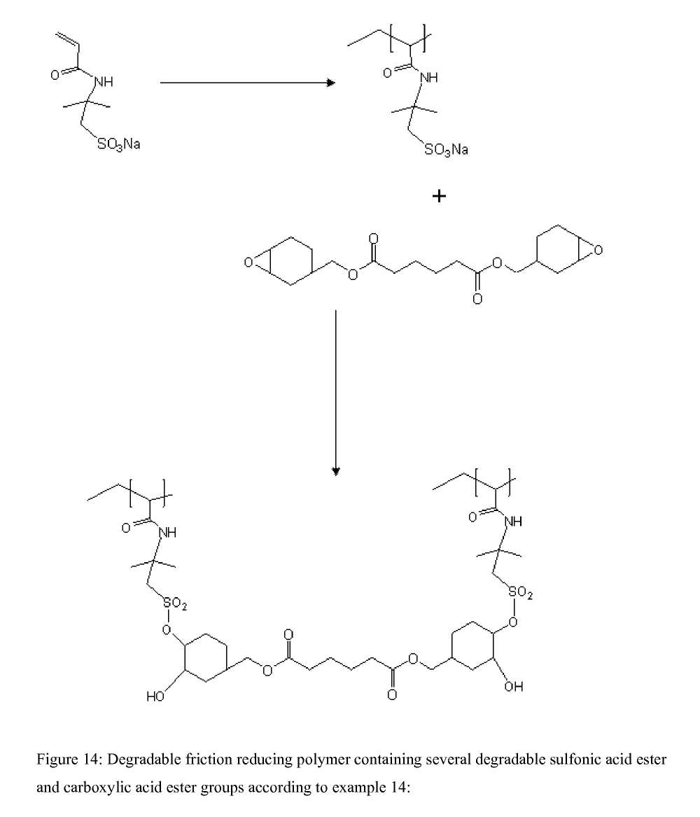

This example, reaction depicted below in FIG. 14, illustrates yet another degradable friction reducer. This copolymer can be obtained by condensation of a polymer obtained by addition polymerization of acrylamido-methyl-propane sodium sulfonate CAS 5165-97-9, the “A” monomer, with a “B monomer” such as Bis(3,4-epoxycyclohexylmethyl) adipate CAS 3130-19-6, yielding a copolymer containing several carboxylic acid ester links and several sulfonic acid ester groups.

### Example 15

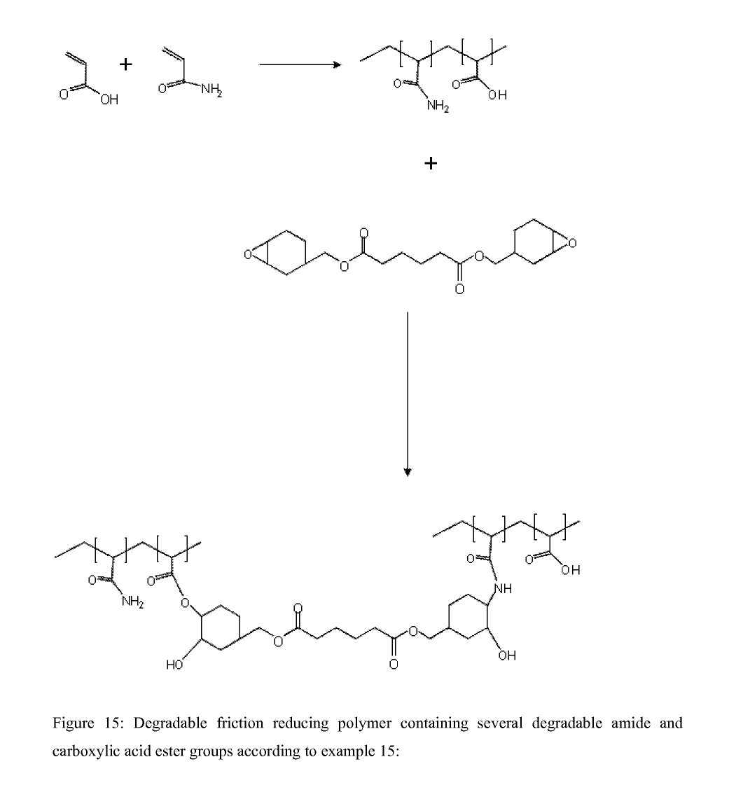

In FIG. 15, illustrated is a reaction to form another embodiment of a degradable friction reducer. This copolymer can be obtained by condensation of a polymer obtained by addition polymerization of acrylamide CAS 79-06-1, and acrylic acid CAS 79-10-7, the “A” monomers, with a “B monomer” such as Bis(3,4-epoxycyclohexylmethyl) adipate CAS 3130-19-6, yielding a copolymer containing several carboxylic acid ester links and several amide groups.

### Example 16

A degradable friction reducer polymer, such as that depicted in FIG. 15, was synthesized in a wearing blender according to the following procedure: 3.0 gr of an emulsion obtained from Nalco containing 54.2% of poly(acrylamide-coacrylic acid) (0.7% polymer), poly(AMAA) polymer was added to 234 g of tap water stirring in a wearing blender at ambient temperature. The mixture was continuously stirred for five minutes resulting in a viscous fluid. The mixing was maintained while the vortex was observed. Subsequently, 4 g of Bis(3,4-epoxycyclohexylmethyl) adipate were added dropletwise to the mixture. Vortex closure was observed, indicating that viscosity if the mixture had increased resulting form an increase of the molecular weight of the polymer obtained by reaction between the sulfonate containing polymer and the epoxy containing monomer. The mixture was allowed to continue mixing without any change on the vortex appearance for 20 minutes. Subsequently 0.05 ml of concentrated 37% hydrochloric acid was added to the mixture. The pH of the mixture was reduced, and the vortex opened again indicating a decrease of viscosity following the degradation of the ester groups in the degradable polymer synthesized.

### Example 17

A degradable friction reducer polymer, such as that depicted in FIG. 15, was synthesized in situ in a friction loop consisting of a series stainless steel tubings connecting the discharge of a triplex pumped to a reservoir open to atmosphere from which the pump was fed. The friction loop was equipped with two differential pressure meters able to continuously measure the friction pressure in 6 ft sections of ⅜″ and ½″ straight pipes. The pump was capable of delivering flow rate upto circa 35 liters per minute. The loop was also equipped with a coriolis flow meter capable to continuously measure density and flow rate. In addition the pump flow rate could be changed by means of suitable electric power control. The friction of water was measured at various flow rates in order to serve as a comparison for the effectiveness of the synthesized degradable friction reducer.

The degradable friction reducer was synthesized insitu according to the following procedure: 8 ml of an emulsion obtained from Nalco containing 54.2% of poly(acrylamide-coacrylic acid) (0.05% polymer), poly(AMAA) was added to the liquid in the reservoir. The total content of the friction loop and container was 8.00 liters of tap water which were continuously pumped around the loop at a rate of approximately 6 liter per minute. In order to homogenize the mixture, the content of the loop and the reservoir was pumped for approximately four minutes at a rate of approximately 20 l per minute, a rate and period of time that is known not to be high enough to degrade the polyAMAA in the configuration of the friction loop. The fluid viscosity was visually inspected and did not substantially increase over that of the water previously pumped around the loop.

4 ml of bis(3,4-epoxycyclohexylmethyl) adipate were added to the liquid in the reservoir while its content was continuously pumped around the loop at a rate of approximately 6 liter per minute. In order to homogenize the mixture, the content of the loop and the reservoir was pumped for approximately four minutes at a rate of approximately 20 liters per minute, a rate and period of time that is known not to be high enough to degrade the polyAMAA in the configuration of the friction loop. The fluid viscosity was visually inspected and did not substantially increase over that of the polymer solution previously pumped around the loop.

Subsequently the friction pressure in the loop was measured as a function of flow rate and pipe diameter. Subsequently the mixture was diluted by addition of tap water ensuring homogenous mixing according to the procedure described above with the aim of ascertaining the minimum effective concentration of the synthesized friction reducer. Finally the pH of the mixture was decreased by addition of 12 ml of concentrated 37% HCl, and the friction of the final mixture was measured. Results of these tests are shown in Table 1 were the most sensitive measurements, those in the ⅜″ pipe are shown at two different flow rates. The pressure differential over a 6 ft of a ⅜″ straight pipe for each mixture ΔPmix was compared to the friction pressure for water ΔPw at the same flow rate, and reported as % DR=100*(1−ΔPmix/ΔPw).

As it is observed in Table 1, the degradable friction reducer reaction product was a better friction reducer than the original poly(AMAA) polymer at low flow rates, while it was a similar friction reducer at higher rates.

The degradable friction reducer reaction product was a very effective friction reducer at concentrations from 1 ml/L, down to 0.5 g/L (experiments 17-2, 17-3 and 17-4), and a quite effective friction reducer at concentrations from 0.33 g/L down to 0.11 g/L (experiments 17-5, 17-6 17-7 and 17-8).

In addition it was observed that the degraded friction reducer at 0.11 g/L (experiment 17-9), which is equivalent to the original polyAMPS showed worse friction reducing capabilities than the degradable friction reducer at equivalent concentration (experiment 17-8).

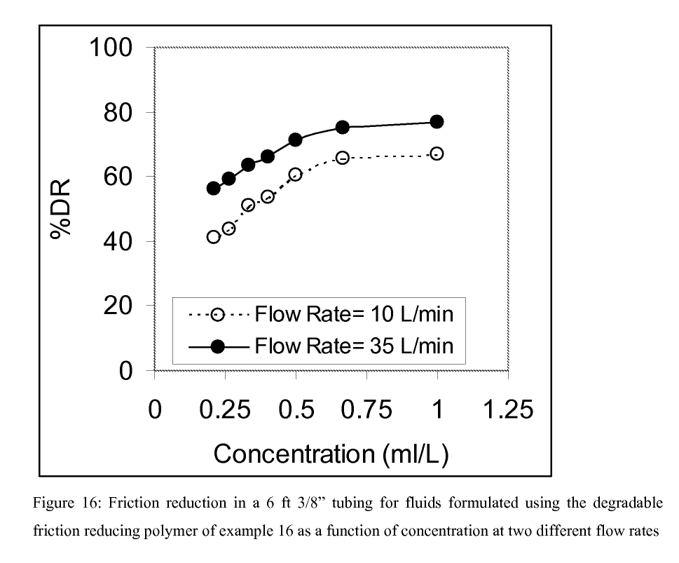

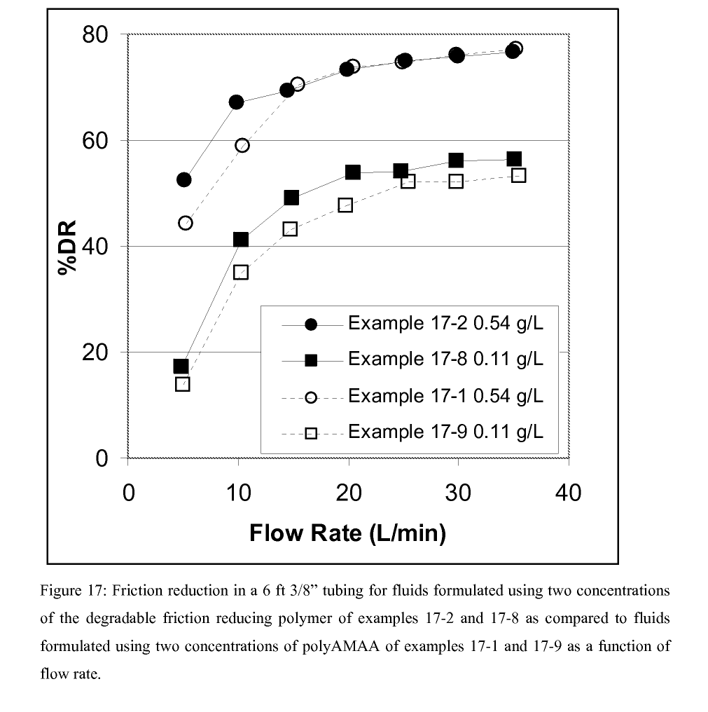

In addition, FIG. 16 compares the friction reduction in a 6 ft ⅜″ tubing for fluids formulated using the degradable friction reducing polymer of example 17 as a function of concentration at two different flow rates, while FIG. 17 shows a comparison of the friction reduction in a 6 ft ⅜″ tubing for fluids formulated using two concentrations of the degradable friction reducing polymer of examples 17-2 and 17-8 as compared to fluids formulated using two concentrations of polyAMAA of examples 17-1 and 17-9 as a function of flow rate.

TABLE 1
Friction reduction results according to compositions prepared in example 17

| | Friction reducing | Concentration g/L | % DR ⅜″ | % DR ⅜″ |
|---|---|---|---|---|
| SAMPLE # | Polymer | “Monomer A” | at 10 L/min | at 35 L/min |
| 17-0 | NONE | N/A | 0 | 0 |
| 17-1 | polyAMPS | 4.3 g/8 L | 59 | 77 |
| 17-2 | Degradable friction reducer | 4.3 g/8 L | 67 | 77 |
| 17-3 | Degradable friction reducer | 4.3 g/12 L | 66 | 75 |
| 17-4 | Degradable friction reducer | 4.3 g/16 L | 61 | 71 |
| 17-5 | Degradable friction reducer | 4.3 g/20 L | 54 | 66 |
| 17-6 | Degradable friction reducer | 4.3 g/24 L | 51 | 63 |
| 17-7 | Degradable friction reducer | 4.3 g/30 L | 44 | 59 |
| 17-8 | Degradable friction reducer | 4.3 g/38 L | 41 | 56 |
| 17-9 | Degraded friction reducer | 4.3 g/38 L | 34.9 | 53.3 |

In the foregoing description, for the purposes of illustration, various methods and/or procedures were described in a particular order. It should be appreciated that in alternate embodiments, the methods and/or procedures may be performed in an order different than that described.

Hence, while detailed descriptions of one or more embodiments of the invention have been given above, various alternatives, modifications, and equivalents will be apparent to those skilled in the art without varying from the spirit of the invention. Moreover, except where clearly inappropriate or otherwise expressly noted, it should be assumed that the features, devices and/or components of different embodiments may be substituted and/or combined. Thus, the above description should not be taken as limiting the scope of the invention, which is defined by the appended claims.

What is claimed is:

1) An aqueous wellbore fluid comprising an aqueous medium and an aqueous solvent soluble synthetic copolymer, the aqueous solvent soluble synthetic copolymer represented by the formula -[(A)ₓ-(B)_{y}]_{z}—, wherein x, y, z are integers equal to or higher than 1, A is a polymer structure comprising non degradable polymer chains, and B is a polymer structure comprising degradable polymer chains, wherein the synthetic copolymer is used as friction reducing agent for wellbore fluids.

2) The aqueous wellbore fluid of claim 1, wherein the A provides 50 wt % of the molecular mass of the polymer.

3) The aqueous wellbore fluid of claim 1, wherein the molecular weight of the A block does not exceed 500,000 Da.

4) The aqueous wellbore fluid of claim 1, wherein the polymer has degradable bonds selected from: degradable coupling bonds linking the A and the B, degradable bonds within the B, and mixtures thereof.

5) The aqueous wellbore fluid of claim 1, wherein chains of the A remain essentially undegraded by chains of the B during a degradation process, and wherein the A is water soluble.

6) The aqueous wellbore fluid of claim 1, wherein the synthetic copolymer may be degraded by a breaking process induced by a process selected from a group consisting of altering pH conditions, altering temperature and altering electrochemical potentials.

7) The aqueous wellbore fluid of claim 1, wherein the synthetic polymer is obtained by addition copolymerization reactions between at least one monomer type A and at least one monomer type B.

8) The aqueous wellbore fluid of claim 8, wherein the synthetic polymer comprises at least one radical initiator decomposition fragment and at least one chain transfer agent reaction fragment.

9) The aqueous wellbore fluid of claim 1, wherein the synthetic polymer is obtained using coupling reactions between terminal groups of at least one of the A and at least one of the B.

10) The aqueous wellbore fluid of claim 1, wherein the backbone of the synthetic polymer contains at least one bond selected from: covalent bonds that can be cleaved by a hydrolytic mechanism catalyzed by acids, encapsulated acids, acid precursors, bases, encapsulated bases, base precursors; covalent bonds that can be cleaved by means of heat/temperature or a redox reaction triggered by the release of a reducing agent; or both.

11) The aqueous wellbore fluid of claim 1, wherein the backbone of the synthetic polymer contains at least one bond selected from the group consisting of nitroxyl, imine, azo, peroxy, perester, percarbonate, carbonate, carboxylic acid ester, thioester, sulfonic acid ester, amide, sulfonamide, urea, and urethane bonds.

12) The aqueous wellbore fluid of claim 1, wherein the backbone of the synthetic polymer contains at least one bond selected from the group consisting of imine, carbonate, carboxylic acid ester, thioester, and sulfonic acid ester bonds.

13) The aqueous wellbore fluid of claim 1, wherein the backbone of the synthetic polymer contains at least one bond selected from the group consisting of nitroxyl, azo, peroxy, perester, and percarbonate.

14) The aqueous wellbore fluid of claim 1, wherein the backbone of the synthetic polymer contains at least one monomer selected from acrylamide, methacrylamide, hydrolyzed acrylamide, hydrolyzed methacrylamide, acrylic acid, methacrylic acid, sodium styrene sulfonate, vinyl sulfonate, 2-(N-3-Sulfopropyl-N,N-dimethyl ammonium)ethyl methacrylate and acrylamido-methyl-propane sulfonic acid salt, vinyl formamide, hydrolyzed vinyl formamide.

15) The aqueous wellbore fluid of claim 1, wherein the synthetic polymer contains at least one monomer comprising functional groups that can bear negative charges at specific pH ranges.

16) The aqueous wellbore fluid of claim 1, wherein the synthetic polymer comprises groups capable of partially hydrolyzing in an aqueous medium resulting in carboxylic acid bearing monomers.

17) The aqueous wellbore fluid of claim 1, wherein the synthetic polymer contains at least one monomer comprising functional groups that can bear positive charges at specific pH ranges.

18) The aqueous wellbore fluid of claim 1, wherein the synthetic polymer is an ampholite.

19) The aqueous wellbore fluid of claim 1, wherein the fluid viscosity at 25 degC at 100 s⁻¹ is lower than about 0.020 Pa s.

20) A high rate water fracturing treatment using the aqueous wellbore fluid of claim 1.

21) A high rate water gravel packing treatment using the aqueous wellbore fluid of claim 1.

22) A matrix acidizing treatment using the aqueous wellbore fluid of claim 1.

23) A friction reducer comprising an aqueous solvent soluble synthetic copolymer represented by the formula -[(A)ₓ-(B)_{y}]_{z}—, wherein x, y, z are integers equal to or greater than 1, A is a polymer structure comprising non degradable polymer chains, and B is a polymer structure comprising degradable polymer chains.

24) The friction reducer of claim 22 as used in treatment fluid to treat a subterranean formation penetrated by a wellbore.

25) An aqueous solvent soluble synthetic copolymer represented by the formula -[(A)ₓ-(B)_{y}]_{z}—, wherein x, y, z are integers equal to or greater than 1, A is a polymer structure comprising non degradable polymer chains, and B is a polymer structure comprising degradable polymer chains, wherein the synthetic copolymer is used as friction reducing agent for wellbore fluids.
